(19) United States
(12) Patent Application Publication
(10) Pub. No.: US 2011/0021083 A1
(43) Pub. Date: Jan. 27, 2011

(54) Dual Impedance Electrical Connector

(75) Inventors: Jonathan E. Buck, Hershey, PA (US); Stephen B. Smith, Mechanicsburg, PA (US)

Correspondence Address: WOODCOCK WASHBURN, LLP, CIRA CENTRE, 12TH FLOOR, 2929 ARCH STREET, PHILADELPHIA, PA, 19104-2891, US

(73) Assignee: FCI AMERICAS TECHNOLOGY, INC., Carson City, NV (US)

(21) Appl. No.: 12/832,489

(22) Filed: Jul. 8, 2010

Related U.S. Application Data
(60) Provisional application No. 61/228,269, filed on Jul. 24, 2009.

(51) Int. Cl. H01R 24/00; H01R 43/00

(52) U.S. Cl. 439/660; 29/876

(57) ABSTRACT

An electrical power connector comprises a housing having a mounting interface and a mating interface. The mating interface defines a plurality of receptacles spaced apart in more than one direction. A plurality of electrical contacts is supported by the housing. These electrical contacts define respective mounting ends that are configured to electrically connect with an electrical component at the mounting interface, and opposed mating ends. At least one of the electrical contacts defines a common contact beam disposed within at least a select one of the receptacles. This common contact beam is configured to be electrically connected to a pair of adjacent electrical contacts of a mated electrical connector.

### CROSS-REFERENCE TO RELATED APPLICATIONS

This application claims the benefit of provisional U.S. Patent Application Ser. No. 61/228,269 filed on Jul. 24, 2009, the disclosure of which is hereby incorporated by reference as if set forth in its entirety herein.

### BACKGROUND

An electrical connector may include a plurality of leadframe assemblies disposed adjacent to one another in a connector housing. The connector may have a mounting interface that defines a first plane and mating interface that defines a second plane. Where the plane of the mating interface is orthogonal to the plane of the mounting interface, the connector may be referred to as a right-angle connector. Where the plane of the mating interface is parallel to the plane of the mounting interface, the connector may be referred to as a mezzanine connector.

Each such leadframe assembly may include a leadframe housing, which may be made of a dielectric material, such as a plastic, for example. A plurality of electrical contacts may extend through the leadframe housing. The contacts may be made of an electrically conductive material. The contacts may be stamped from a sheet of electrically-conductive material to form a leadframe. The leadframe housing may be overmolded onto the leadframe. Such a leadframe assembly may be referred to as an insert-molded leadframe assembly (IMLA).

Each contact may have a mating end, which may be a receptacle, blade, or other desirable mating end. Each contact may have a respective mounting end, which may be an eye-of-the-needle type mounting end, or a pin, ball, or other desirable mounting end, or terminate in a fusible mounting element, such as a solder ball, for example.

The mating ends of the contacts within a leadframe assembly may form a linear array extending along a first direction. The mating ends of the contacts may be arranged along a common centerline that extends along the first direction. The mounting ends of the contacts may form a linear array extending along a second direction, which may be parallel to the first direction (in the case of a mezzanine connector) or perpendicular to the first direction (in the case of a right angle connector). The mounting ends of the contacts may align along a common centerline that extends along the second direction.

Differential signal pairs of electrical contacts may be arranged edge to edge (i.e., edge-coupled) or broadside-to-broadside (i.e., broadside-coupled). Contacts may be arranged in a signal-signal-ground arrangement along either columns or rows.

A differential signal pair has a differential impedance between the positive conductor and negative conductor of the differential signal pair. Differential impedance is defined as the impedance existing between two signal conductors of the same differential signal pair, at a particular point along the length of the differential signal pair. It is desirable to control the differential impedance to match the impedance of the electrical device(s) to which the connector is connected. Matching the differential impedance to the impedance of electrical device minimizes signal reflection and/or system resonance that can limit overall system bandwidth. Furthermore, it is desirable to control the differential impedance such that it is substantially constant along the length of the differential signal pair, i.e., such that each differential signal pair has a substantially consistent differential impedance profile.

The differential impedance profile can be controlled by the positioning of the signal and ground contacts. Specifically, differential impedance may be determined by the proximity of the signal contact to an adjacent ground contact, and by the gap between edges of signal contacts within a differential signal pair.

To maintain acceptable differential impedance control for high bandwidth systems, it is desirable to control the gap between contacts to within a few thousandths of an inch. Gap variations beyond a few thousandths of an inch may cause an unacceptable variation in the impedance profile; however, the acceptable variation is dependent on the speed desired, the error rate acceptable, and other design factors.

In addition to conductor placement, differential impedance may be affected by the dielectric properties of material proximate to the conductors. Generally, it is desirable to have materials having very low dielectric constants adjacent and in contact with as much of the conductors as possible. The use of air rather than plastic as a dielectric provides a number of benefits.

Additional background may be found in U.S. Pat. No. 7,270,574, U.S. Pat. No. 6,994,569, and U.S. Patent Application Ser. No. 61/141,990, filed Dec. 31, 2008, the disclosure of each of which is incorporated herein by reference.

### SUMMARY

As disclosed herein, an electrical connector may include a plurality of electrical contacts arranged into rows and columns. An edge-coupled differential signal pair of the contacts may provide a first pre-established differential impedance, while a broadside-coupled differential signal pair of the contacts may provide a second pre-established differential impedance, which may be different from the first pre-established differential impedance. Accordingly, a single connector may be designed to provide an 85±10 Ω differential impedance when wired for edge-coupled pairs and a 100±10 Ω differential impedance when wired for broadside-coupled pairs.

As used herein, the term “pre-established differential impedance” refers to a differential impedance that is designed into the connector, as distinct from a differential impedance that exists merely as a fallout of the design. In other words, the connector is designed to provide two specific differential impedances that are known a priori, as distinct from prior art connectors that are designed to provide one pre-established differential impedance, while the other is not designed into the connector, but rather merely a fallout of design.

### BRIEF DESCRIPTION OF THE DRAWINGS

FIG. 1 depicts an example mezzanine-style electrical connector.

FIGS. 2A and 2B depict partial sectional views of the connector in FIG. 1 along plane A and shows different differential signal pair designations within an example contact arrangement.

FIG. 3 depicts certain structural aspects of a contact arrangement that may be varied to affect differential impedance.

FIG. 4 depicts an example contact arrangement with dielectric walls disposed between columns of electrical contacts.

FIGS. 5A and 5B depict rotation of an example contact arrangement to affect differential impedance.

### DETAILED DESCRIPTION

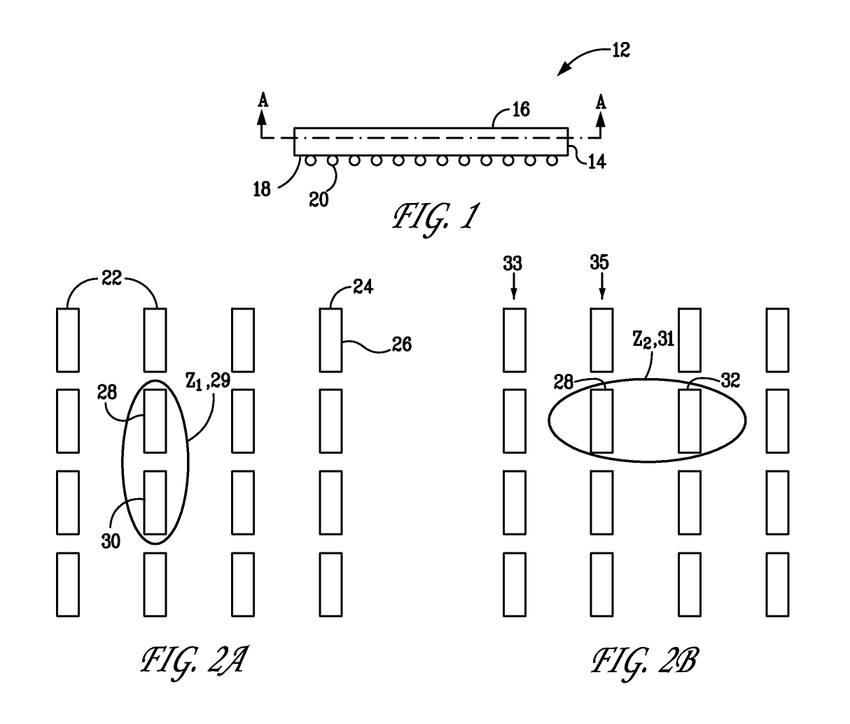

FIG. 1 depicts an example mezzanine-style electrical connector 12. Such a connector may include a connector housing 14, which may be made of a dielectric material, such as a plastic. The connector 12 may include a plurality of electrical contacts (shown in FIGS. 2A and 2B). Each contact may have a respective mating end 16 and a respective mounting end 18. The mounting ends may terminate in fusible elements, such as solder balls 20. Such a connector 12 may be referred to as a ball grid array connector. The arrangement of the mounting ends 18 may define the connector's “footprint.”

FIGS. 2A and 2B show arrangements of the contacts of connector 12 according to partial sectional views along plane A of connector 12 as indicated by FIG. 1. FIGS. 2A and 2B also depict different differential signal pair designations 29, 31 within an example contact arrangement. As shown, each of the contacts 22 may have a respective edge 24 and a respective broadside 26, where the broadside of the contact is wider than the edge. First and second contacts 28, 30 are positioned edge-to-edge along a first direction as highlighted in FIG. 2A by signal pair designation 29. The first contact 28 may be positioned broadside-to-broadside with a third contact 32 along a second direction that is perpendicular to the first direction as highlighted in FIG. 2B by signal pair designation 31.

The first and second contacts 28, 30 may define an edge-coupled differential signal pair 29 having a first pre-established differential impedance Z₁. The first and third contacts 28, 32 may define a broadside-coupled differential signal pair 31 having a second pre-established differential impedance Z₂ that is different from the first pre-established differential impedance Z₁. For example, the first pre-established differential impedance Z₁ may be 85 ohms, while the second pre-established differential impedance is 100 ohms Z₂.

As used herein, a stated differential impedance value refers to the stated value plus or minus 10% tolerance for that value. For example, the stated value “100 Ω” refers to 100 Ω±10%, or 90-110 Ω. Similarly, the stated value “85 Ω” refers to 85 Ω±10%, or 76.5-93.5 Ω.

FIG. 3 depicts certain structural aspects of a contact arrangement that may be varied to affect differential impedance. For example, the distance between the adjacent edges 24 of the first and second contacts 28, 30 may be varied, as may the distance between the centerlines of adjacent columns 33, 35. Adjacent columns 33, 35 refer to the columns of contacts 24 arranged edge to edge in FIG. 3. The distance between the adjacent edges of the first and second contacts may be referred to as the “gap width” shown as “g” in FIG. 3. Adjusting the gap width g may affect the distance between the adjacent edges 24 of the first and second contacts 28, 30. The distance between the centerlines of adjacent columns may be referred to as the “column pitch” shown as “p” in FIG. 3. Adjusting the column pitch may affect the distance between the adjacent broadsides 26 of the first and third contacts 28, 32.

The gap width g and column pitch p may be chosen such that the first and second electrical contacts 28, 30 provide the first pre-established differential impedance Z₁, while the first and third electrical contacts 28, 32 provide the second pre-established differential impedance Z₂. In other words, the connector may be designed to have a gap width g and column pitch p that cooperate to provide two pre-established differential impedances Z₁, Z₂ in a single connector. That is, the first and second electrical contacts 28, 30 may be separated by a first distance along the first direction, and the first and third electrical contacts 28, 32 may be separated by a second distance along the second direction, such that the first and second electrical contacts 28, 32 provide a first pre-established differential impedance Z₁ and the first and third contacts provide a second pre-established differential impedance Z₂. Thus, the contacts may be positioned relative to one another such that the first and second pre-established differential impedances Z₁, Z₂ provided are provided as a result of the arrangement.

It should be understood that a contact arrangement such as shown herein may include both edge-coupled and broadside-coupled differential signal pairs 29, 31. Thus, the same connector 12 may simultaneously provide both of two pre-established differential impedances Z₁, Z₂.

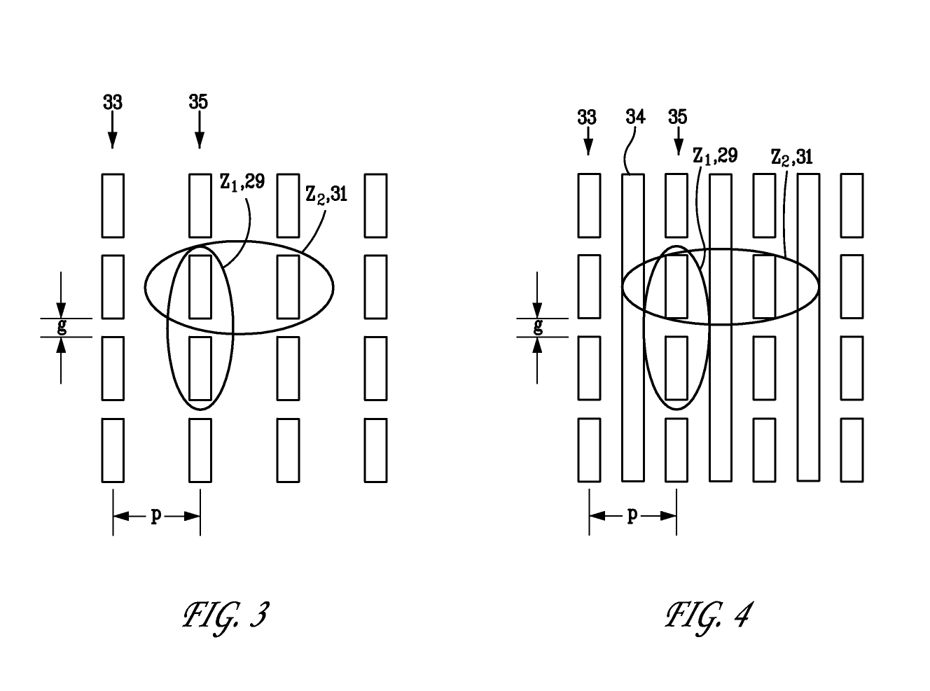

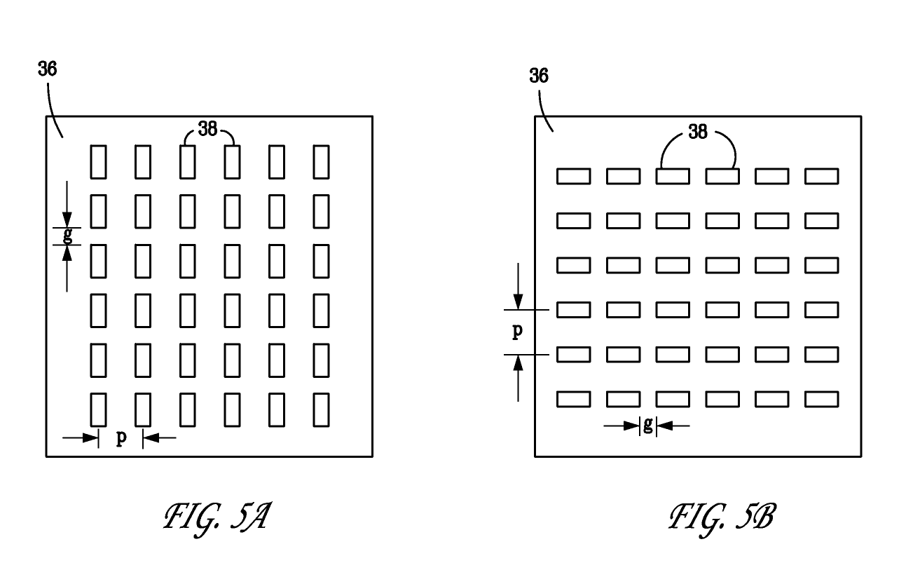

As shown in FIG. 4, a dielectric material 34, such as a plastic, for example, may be disposed between the broadsides of adjacent contacts. The dielectric material 34 may be a dielectric wall disposed between adjacent contact columns 33, 35.

As shown in FIGS. 5A and 5B, such a connector 12 may be mounted onto a substrate 36. By way of example, the substrate 36 may be a printed circuit board and the connector 12 may be mounted in any of a plurality of orientations. Such a substrate 36 may have an arrangement electrically conductive elements 38, such as pads or through-holes. The electrically conductive elements 38 may be arranged in an arrangement corresponding to the connector footprint, such that, when the connector 12 is mounted onto the substrate 36, mounting ends of the contacts 22 may make electrical contact with the electrically conductive elements on the substrate.

The substrate 36 may be wired such that a certain two of the electrically conductive elements 38 form a differential signal pair. A connector 12 having a square grid footprint (of solder balls or compliant terminal ends, for example), may be set on the substrate 36 in a first orientation, as shown in FIG. 5A, or in a second orientation, as shown in FIG. 5B, that is rotated 90° relative to the first orientation. It should be understood that, when the connector 12 is mounted as shown in FIG. 5A, the connector 12 will provide the first differential impedance Z₁, and, when the connector 12 is mounted as shown in FIG. 5B, the connector 12 will provide the second differential impedance Z₂. Accordingly, the same connector 12 can provide a selected one of at least two different, pre-established differential impedances Z₁, Z₂, on the same substrate 36, depending on how it is oriented on the substrate. This is advantageous because a single part is capable of producing two distinct impedances.

As described above, an electrical connector 12 may be provided by pre-establishing two desired differential impedances Z₁, Z₂, and then designing the connector 12 such that an edge-coupled differential signal pair 29 provides the first of the two differential impedances Z₁, while a broadside-coupled differential signal pair 31 in the same connector 12 provides the second of the two differential impedances Z₂.

In an example embodiment, the contacts 22 may be arranged in a square grid, with a column pitch of 1.4 mm and row pitch of 1.4 mm. The contacts may be 0.35 mm thick (i.e., have 0.35 mm edges) and 1.0 mm wide (i.e., have 1.0 mm broadsides). Thus, the gap width between adjacent contacts in a column maybe 0.4 mm, and the distance between broadsides of adjacent contacts in a row may be 1.05 mm. A dielectric material having a thickness of 0.8 mm may be disposed between the columns, i.e., between the broadsides of adjacent contacts. Thus, the dielectric may be spaced 0.125 mm from the broadsides of the contacts.

In such a connector 12, where the contacts 22 along a column were arranged in a ground-signal-signal-ground arrangement, the differential impedance Z₁ of an edge-coupled differential signal pair 29 was found to be 82-83 Ω. In the same connector 12, where the contacts 22 along a row were arranged in a ground-signal-signal-ground arrangement, the differential impedance Z₂ of a broadside-coupled differential signal pair 31 was found to be 98-99 Ω.

1. An electrical connector, comprising:
a first electrical contact having an edge and a broadside;
a second electrical contact having an edge and a broadside; and
a third electrical contact having an edge and a broadside,
wherein the first and second electrical contacts are positioned edge-to-edge along a first direction, the first and third electrical contacts are positioned broadside-to-broadside along a second direction that is perpendicular to the first direction, the first and second electrical contacts provide a first pre-established differential impedance, and the first and third electrical contacts provide a second pre-established differential impedance.

2. The electrical connector of claim 1, wherein the first pre-established differential impedance is 85±10 ohms and the second pre-established differential impedance is 100±10 ohms.

3. The electrical connector of claim 1, further comprising a dielectric material between the first and third contacts.

4. The electrical connector of claim 1, wherein the first and second electrical contacts are separated by a first distance along the first direction, and the first and third electrical contacts are separated by a second distance along the second direction, such that the first and second electrical contacts provide the first pre-established differential impedance, and such that the first and third electrical contacts provide the second pre-established differential impedance.

5. The electrical connector of claim 4 wherein the first pre-established differential impedance is a function of the first distance and wherein the second pre-established differential impedance is a function of the second distance.

6. An electrical connector, comprising:
a connector housing;
first and second electrical contacts arranged edge-to-edge within the connector housing; and
third and fourth electrical contacts arranged broadside-to-broadside within the connector housing,
wherein the first and second electrical contacts provide a first pre-established differential impedance, and the third and fourth electrical contacts provide a second pre-established differential impedance.

7. An electrical connector system, comprising:
an electrical connector comprising a plurality of electrical contacts, each said contact having a respective mounting end, the mounting ends defining a connector footprint; and
a substrate having an arrangement of electrically conductive elements corresponding to the connector footprint,
wherein the connector provides a first pre-established differential impedance when mounted on the substrate in a first orientation, and a second pre-established differential impedance when mounted on the substrate in a second orientation, the second differential impedance being different from the first differential impedance, the second orientation being different from the first orientation.

8. An electrical connector, comprising:
a first electrical contact;
a second electrical contact positioned adjacent to the first electrical contact along a first direction; and
a third electrical contact positioned adjacent to the first electrical contact along a second direction that is perpendicular to the first direction,
wherein the first electrical contact and the second electrical contact provide a differential impedance of 85±10 ohms, the first electrical contact and the third electrical contact provide a differential impedance of 100±10 ohms.

9. The electrical connector of claim 8, wherein the contacts are positioned relative to one another such that the differential impedance of 85±10 ohms is provided as a result of the arrangement.

10. The electrical connector of claim 9, wherein the contacts are positioned relative to one another such that the differential impedance of 100±10 ohms is provided as a result of the arrangement.

11. The electrical connector of claim 8, wherein the first and second electrical contacts are separated by a first distance along the first direction, and the first and third electrical contacts are separated by a second distance along the second direction, such that the first and second electrical contacts provide the differential impedance of 85±10 ohms, such that the first and third electrical contacts provide the differential impedance of 100±10 ohms.

12. The method of claim 8, wherein each of the signal contacts has a respective broadside and a respective edge, the first and second signal contacts are positioned edge-to-edge, and the first and third signal contacts are positioned broadside-to-broadside.

13. The electrical connector of claim 12, further comprising a dielectric material between the first and third contacts.

14. A method for designing an electrical connector, the method comprising:
identifying a first differential impedance;
identifying a second differential impedance that is different from the first differential impedance; and
providing an electrical connector comprising a first signal contact, a second signal contact positioned adjacent to the first signal contact along a first direction, and a third signal contact positioned adjacent to the first signal contact along a second direction that is perpendicular to the first direction, wherein the first signal contact and the second signal contact provide the first differential impedance, and the first signal contact and the third signal contact provide the second differential impedance.

15. The method of claim 14, wherein the first differential impedance is 85±10 ohms and the second differential impedance is 100±10 ohms.

16. The method of claim 15, wherein each of the signal contacts has a respective broadside and a respective edge, the first and second signal contacts are positioned edge-to-edge, and the first and third signal contacts are positioned broadside-to-broadside.

17. The method of claim 16, wherein the connector further comprises a dielectric material between the first and third contacts.

18. The method of claim 16, wherein the first and second signal contacts are disposed in a first leadframe housing.

19. The method of claim 18, wherein the third signal contact is disposed in a second leadframe housing that is adjacent to the first leadframe housing.

20. The method of claim 14, wherein the first and second signal contacts are separated by a first distance along the first direction, and the first and third signal contacts are separated by a second distance along the second direction, the method further comprising:
determining the first and second distances such that the first and second signal contacts provide the first differential impedance and the first and third signal contacts provide the second differential impedance.
